(19) United States
(12) Patent Application Publication
(10) Pub. No.: US 2005/0120185 A1
(43) Pub. Date: Jun. 2, 2005

(54) Methods and apparatus for efficient multi-tasking

(75) Inventors: Takeshi Yamazaki, Austin, TX (US); Michael Norman Day, Round Rock, TX (US); Thuong Truong, Austin, TX (US)

Correspondence Address: LERNER, DAVID, LITTENBERG,;KRUMHOLZ & MENTLIK, 600 SOUTH AVENUE WEST, WESTFIELD, NJ, 07090, US

(73) Assignees: Sony Computer Entertainment Inc., Tokyo (JP); International Business Machines Corporation, Armonk, NY (US)

(21) Appl. No.: 10/725,129

(22) Filed: Dec. 1, 2003

(51) Int. Cl. G06F 12/14; G06F 12/16; G06F 13/28

(52) U.S. Cl. 711/147

(57) ABSTRACT

A system includes a shared memory; a memory interface unit coupled to the shared memory and operable to retrieve data from the shared memory at requested addresses, and to write data to the shared memory at requested addresses; and a plurality of processing units in communication with the memory interface and operable to (i) instruct the memory interface unit that data be loaded with reservation from the shared memory at a specified address such that any operations may be performed on the data, and (ii) instruct the memory interface unit that the data be stored in the shared memory at the specified address, wherein at least one of the processing units includes a status register having one or more bits indicating whether a reservation was lost: whether the data at the specified address in shared memory was modified.

### BACKGROUND OF THE INVENTION

The present invention relates to methods and apparatus for efficient data processing using a multi-processor architecture for computer processors and, in particular, for efficient multi-tasking in a broadband processing environment employing one or more shared memories.

Real-time, multimedia, applications are becoming increasingly important. These applications require extremely fast processing speeds, such as many thousands of megabits of data per second. While single processing units are capable of fast processing speeds, they cannot generally match the processing speeds of multi-processor architectures. Indeed, in multi-processor systems, a plurality of processors can operate in parallel (or at least in concert) to achieve desired processing results.

The types of computers and computing devices that may employ multi-processing techniques are extensive. In addition to personal computers (PCs) and servers, these computing devices include cellular telephones, mobile computers, personal digital assistants (PDAs), set top boxes, digital televisions and many others.

A design concern in a multi-processor system is how to manage the use of a shared memory among a plurality of processing units. Indeed, synchronization of the processors may be needed to achieve a desirable processing result, which may require multi-exclusion operations. For example, proper synchronization may be achieved utilizing so-called atomic read sequences, atomic modify sequences, and/or atomic write sequences.

A further concern in such multi-processor systems is managing the heat created by the plurality of processors, particularly when they are utilized in a small package, such as a hand-held device or the like. While mechanical heat management techniques may be employed, they are not entirely satisfactory because they add recurring material and labor costs to the final product. Mechanical heat management techniques also might not provide sufficient cooling.

Another concern in multi-processor systems is the efficient use of available battery power, particularly when multiple processors are used in portable devices, such as lap-top computers, hand held devices and the like. Indeed, the more processors that are employed in a given system, the more power will be drawn from the power source. Generally, the amount of power drawn by a given processor is a function of the number of instructions being executed by the processor and the clock frequency at which the processor operates.

Therefore, there is a need in the art for new methods and apparatus for achieving efficient multi-processing that reduces heat produced by the processors and the energy drawn thereby.

### SUMMARY OF THE INVENTION

A new computer architecture has also been developed in order to overcome at least some of the problems discussed above.

In accordance with this new computer architecture, all processors of a multi-processor computer system are constructed from a common computing module (or cell). This common computing module has a consistent structure and preferably employs the same instruction set architecture. The multi-processor computer system can be formed of one or more clients, servers, PCs, mobile computers, game machines, PDAs, set top boxes, appliances, digital televisions and other devices using computer processors.

A plurality of the computer systems may be members of a network if desired. The consistent modular structure enables efficient, high speed processing of applications and data by the multi-processor computer system, and if a network is employed, the rapid transmission of applications and data over the network. This structure also simplifies the building of members of the network of various sizes and processing power and the preparation of applications for processing by these members.

The basic processing module is a processor element (PE). A PE preferably comprises a processing unit (PU), a direct memory access controller (DMAC) and a plurality of attached processing units (APUs), such as four APUs, coupled over a common internal address and data bus. The PU and the APUs interact with a shared dynamic random access memory (DRAM), which may have a cross-bar architecture. The PU schedules and orchestrates the processing of data and applications by the APUs. The APUs perform this processing in a parallel and independent manner. The DMAC controls accesses by the APUs to the data and applications stored in the shared DRAM.

In accordance with this modular structure, the number of PEs employed by a particular computer system is based upon the processing power required by that system. For example, a server may employ four PEs, a workstation may employ two PEs and a PDA may employ one PE. The number of APUs of a PE assigned to processing a particular software cell depends upon the complexity and magnitude of the programs and data within the cell.

The plurality of PEs may be associated with a shared DRAM, and the DRAM may be segregated into a plurality of sections, each of these sections being segregated into a plurality of memory banks. Each section of the DRAM may be controlled by a bank controller, and each DMAC of a PE may access each bank controller. The DMAC of each PE may, in this configuration, access any portion of the shared DRAM.

The new computer architecture also employs a new programming model that provides for transmitting data and applications over a network and for processing data and applications among the network's members. This programming model employs a software cell transmitted over the network for processing by any of the network's members. Each software cell has the same structure and can contain both applications and data. As a result of the high speed processing and transmission speed provided by the modular computer architecture, these cells can be rapidly processed. The code for the applications preferably is based upon the same common instruction set and ISA. Each software cell preferably contains a global identification (global ID) and information describing the amount of computing resources required for the cell's processing. Since all computing resources have the same basic structure and employ the same ISA, the particular resource performing this processing can be located anywhere on the network and dynamically assigned.

In accordance with one or more aspects of the present invention, a method includes: a) issuing a load with reservation instruction including a requested address to a shared memory at which data may be located; and b) receiving the data from the shared memory such that any operations may be performed on the data. The method also preferably includes c) at least one of: (i) entering a low power consumption mode, and (ii) initiating another processing task; and d) receiving notification that the reservation was lost, the reservation being lost when the data at the address in shared memory is modified.

Preferably, the notification that the reservation was lost operates as an interrupt that at least one of (i) interrupts the low power consumption mode; and (ii) interrupts the other processing task. Steps a) through d) of the method are preferably repeated when the notification indicates that the reservation was lost.

The method may also include writing an identification number, associated with a processor issuing the load with reservation instruction, into a status location associated with the addressed location in the shared memory when the data is accessed from the shared memory.

Additionally, the method may include monitoring whether the reservation is lost by monitoring whether the data at the address in shared memory is modified. Preferably, the method further includes causing a reservation lost bit in a status register of the processor to indicate that the reservation was lost when a modification to the data at the address in shared memory is made before the data is stored in the shared memory in response to the store instruction. The step of determining whether the reservation was lost may include polling the status register and determining that the reservation was lost when the reservation lost bit so indicates.

In accordance with one or more further aspects of the present invention, a system may include: a shared memory; a memory interface unit operatively coupled to the shared memory; and a plurality of processing units in communication with the memory interface. At least one of the processing units is preferably operable to perform one or more of the steps discussed above with respect to the methods of the invention.

In accordance with one or more further aspects of the present invention, a system includes: a shared memory; a memory interface unit coupled to the shared memory and operable to retrieve data from the shared memory at requested addresses, and to write data to the shared memory at requested addresses; and a plurality of processing units in communication with the memory interface.

The processing units are preferably operable to (i) instruct the memory interface unit that data be loaded with reservation from the shared memory at a specified address such that any operations may be performed on the data, and (ii) instruct the memory interface unit that the data be stored in the shared memory at the specified address. At least one of the processing units preferably includes a status register having one or more bits indicating whether a reservation was lost, the reservation being lost when a modification to the data at the specified address in shared memory is made by another processing unit.

The at least one processing unit is preferably operable to enter into a low power consumption mode when the data is not a predetermined value. The at least one processing unit is preferably further operable to exit the low power consumption mode in response to an event that is permitted to interrupt the low power consumption mode. The at least one processing unit is preferably further operable to poll the one or more bits of the status register to determine whether the event occurred.

The at least one processing unit is preferably further operable to re-instruct the memory interface unit to load the data with reservation from the shared memory at the specified address such that any operations may be performed on the data when the one or more bits of the status register indicate that the reservation was lost.

The event that is permitted to interrupt the low power consumption mode may be that the reservation was lost. Alternatively, or in addition, the event that is permitted to interrupt the low power consumption mode may be an acknowledgement that the data was stored in the shared memory at the specified address.

Preferably, the memory interface unit is operable to write an identification number, associated with the at least one processing unit issuing the load with reservation instruction, into a status location associated with the specified address of the shared memory when the data is accessed from the shared memory. The memory interface unit is preferably further operable to monitor whether the reservation is lost by monitoring whether the data at the specified address in shared memory is modified.

Preferably, the memory interface unit is still further operable to cause the one or more bits of the status register of the at least one processing unit to indicate that the reservation was lost when the data at the specified address in shared memory is modified.

In accordance with one or more further aspects of the present invention, a system includes: a shared memory; a memory interface unit coupled to the shared memory and operable to retrieve data from the shared memory at requested addresses, and to write data to the shared memory at requested addresses; and a plurality of processing units in communication with the memory interface. The processing units are preferably operable to (i) instruct the memory interface unit that data be loaded with reservation from the shared memory at a specified address such that any operations may be performed on the data, and (ii) enter into a low power consumption mode.

The at least one processing unit is preferably further operable to exit the low power consumption mode in response to an event that is permitted to interrupt the low power consumption mode. The event that is permitted to interrupt the low power consumption mode may be that the reservation was lost. Alternatively, or in addition, the event that is permitted to interrupt the low power consumption mode may be an acknowledgement that the data was stored in the shared memory at the specified address.

Preferably, the at least one processing unit includes a status register having one or more bits indicating whether a reservation was lost, e.g., whether the data at the specified address in shared memory is modified.

The memory interface unit is preferably operable to cause the one or more bits of the status register of the at least one processing unit to indicate that the reservation was lost when the data at the specified address in shared memory is modified.

Preferably, the at least one processing unit is further operable to poll the one or more bits of the status register to determine whether the reservation was lost. The at least one processing unit is preferably further operable to re-instruct the memory interface unit to load the data with reservation from the shared memory at the specified address such that any operations may be performed on the data when the one or more bits of the status register indicate that the reservation was lost.

Preferably, the memory interface unit is operable to write an identification number, associated with the at least one processing unit issuing the load with reservation instruction, into a status location associated with the specified address of the shared memory when the data is accessed from the shared memory. The memory interface unit is preferably further operable to monitor whether the data at the specified address in shared memory is modified.

Other aspects, features, and advantages of the present invention will be apparent to one skilled in the art from the description herein taken in conjunction with the accompanying drawings.

### DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a diagram illustrating an exemplary structure of a processor element (PE) in accordance with the present invention;

FIG. 2 is a diagram illustrating the structure of an exemplary broadband engine (BE) in accordance with the present invention;

FIG. 3 is a diagram illustrating the structure of an exemplary attached processing unit (APU) in accordance with the present invention;

FIG. 4 is an alternative configuration suitable for implementing a multi-processor system in accordance with one or more aspects of the present invention;

FIG. 5 is a flow diagram illustrating one or more aspects of a processing routine in accordance with the present invention;

FIG. 6 is a flow diagram illustrating one or more further aspects of a processing routine in accordance with the present invention;

FIG. 7 is a flow diagram illustrating one or more further aspects of a processing routine in accordance with the present invention;

FIG. 8 is a flow diagram illustrating one or more further aspects of a processing routine in accordance with the present invention; and

FIG. 9 illustrates the overall architecture of an exemplary computer network in accordance with the present invention.

### DETAILED DESCRIPTION OF THE PREFERRED EMBODIMENTS

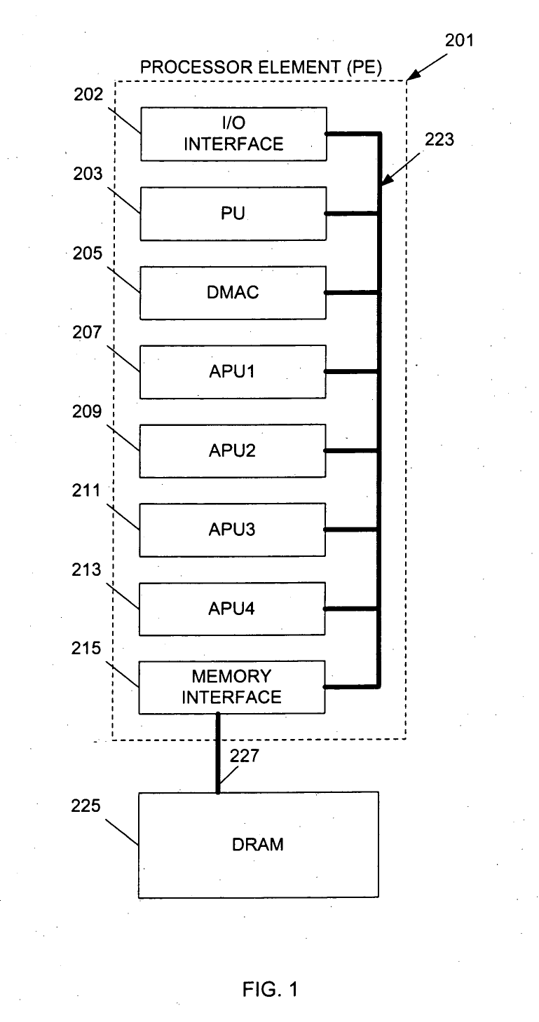

Referring now to the drawings wherein like numerals indicate like elements, there is shown in FIG. 1 a block diagram of a basic processing module or processor element (PE) in accordance with one or more aspects of the present invention. As shown in this figure, PE 201 comprises an I/O interface 202, a processing unit (PU) 203, a direct memory access controller (DMAC) 205, and a plurality of attached processing units (APUs), namely, APU 207, APU 209, APU 211, and APU 213. A local (or internal) PE bus 223 transmits data and applications among PU 203, the APUs, DMAC 205, and a memory interface 215. Local PE bus 223 can have, e.g., a conventional architecture or can be implemented as a packet switch network. Implementation as a packet switch network, while requiring more hardware, increases available bandwidth.

PE 201 can be constructed using various methods for implementing digital logic. PE 201 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. PE 201 also could be implemented using superconducting material, e.g., rapid single-flux-quantum (RSFQ) logic.

PE 201 is closely associated with a dynamic random access memory (DRAM) 225 through a high bandwidth memory connection 227. DRAM 225 functions as the main memory for PE 201. Although a DRAM 225 preferably is a dynamic random access memory, DRAM 225 could be implemented using other means, e.g., as a static random access memory (SRAM), a magnetic random access memory (MRAM), an optical memory or a holographic memory. DMAC 205 and memory interface 215 facilitate the transfer of data between DRAM 225 and the APUs and PU 203 of PE 201.

It is noted that the DMAC 205 and/or the memory may be integrally disposed within one or more of the APUs and the PU 203. It is noted that the PU 203 may be implemented by one of the APUs taking on the role of a main-processing unit that schedules and/or orchestrates the processing of data and applications by the APUs.

PU 203 can be, e.g., a standard processor capable of stand-alone processing of data and applications. In operation, PU 203 schedules and orchestrates the processing of data and applications by the APUs. The APUs preferably are single instruction, multiple data (SIMD) processors. Under the control of PU 203, the APUs perform the processing of these data and applications in a parallel and independent manner. DMAC 205 controls accesses by PU 203 and the APUs to the data and applications stored in the shared DRAM 225.

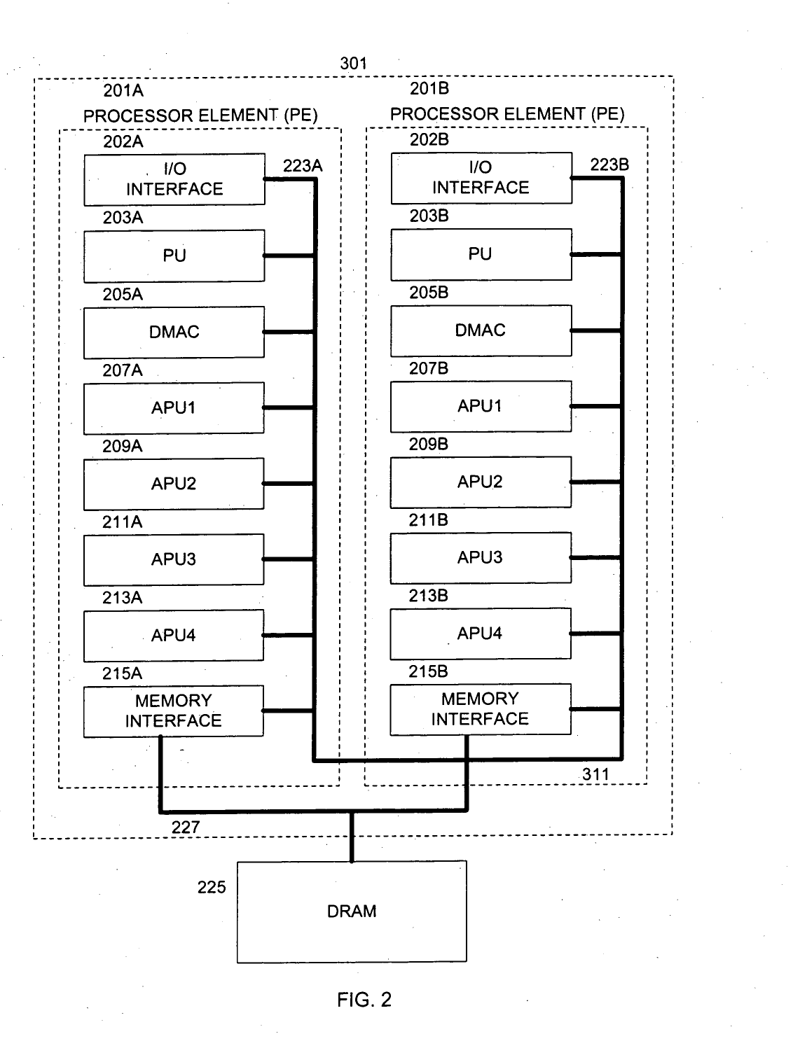

A number of PEs, such as PE 201, may be joined or packaged together to provide enhanced processing power. For example, as shown in FIG. 2, two or more PEs may be packaged or joined together, e.g., within one or more chip packages, to form a single processor system. This configuration is designated a broadband engine (BE). As shown in FIG. 2, BE 301 contains two PEs, namely, PE 201A and PE 201B. Communications among these PEs are conducted over BE bus 311. Broad bandwidth memory connection 227 provides communication between shared DRAM 225 and these PEs. In lieu of BE bus 311, communications among the PEs of BE 301 can occur through DRAM 225 and this memory connection.

One or more input/output (I/O) interfaces 202A and 202B and an external bus (not shown) provide communications between broadband engine 301 and the other external devices. Each PE 201A and 201B of BE 301 performs processing of data and applications in a parallel and independent manner analogous to the parallel and independent processing of applications and data performed by the APUs of a PE.

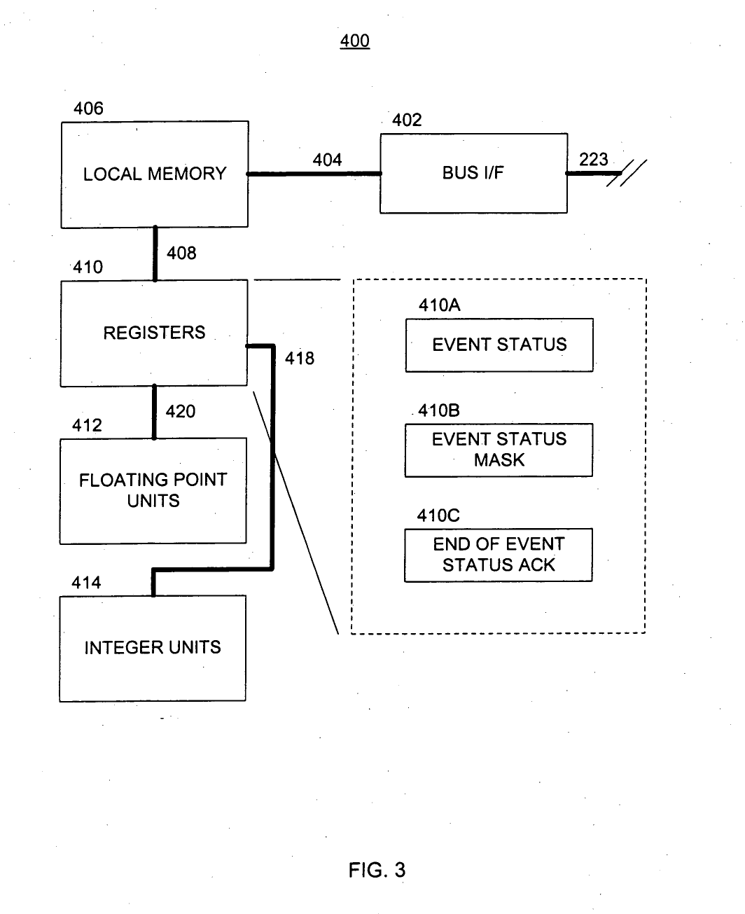

FIG. 3 illustrates the structure and function of an APU 400. APU 400 includes local memory 406, registers 410, one ore more floating point units 412 and one or more integer units 414. Again, however, depending upon the processing power required, a greater or lesser number of floating points units 412 and integer units 414 may be employed. In a preferred embodiment, local memory 406 contains 256 kilobytes of storage, and the capacity of registers 410 is 128×128 bits. Floating point units 412 preferably operate at a speed of 32 billion floating point operations per second (32 GFLOPS), and integer units 414 preferably operate at a speed of 32 billion operations per second (32 GOPS).

Local memory 406 is preferably not a cache memory. Cache coherency support for an APU is unnecessary. Instead, local memory 406 is preferably constructed as a static random access memory (SRAM). A PU 203 may require cache coherency support for direct memory accesses initiated by the PU 203. Cache coherency support is not required, however, for direct memory accesses initiated by the APU 400 or for accesses from and to external devices.

APU 400 further includes bus 404 for transmitting applications and data to and from the APU 400. In a preferred embodiment, bus 404 is 1,024 bits wide. APU 400 further includes internal busses 408, 420 and 418. In a preferred embodiment, bus 408 has a width of 256 bits and provides communications between local memory 406 and registers 410. Busses 420 and 418 provide communications between, respectively, registers 410 and floating point units 412, and registers 410 and integer units 414. In a preferred embodiment, the width of busses 418 and 420 from registers 410 to the floating point or integer units is 384 bits, and the width of busses 418 and 420 from the floating point or integer units 412, 414 to registers 410 is 128 bits. The larger width of these busses from registers 410 to the floating point or integer units 412, 414 than from these units to registers 410 accommodates the larger data flow from registers 410 during processing. A maximum of three words are needed for each calculation. The result of each calculation, however, normally is only one word.

The registers 410 of the APU 400 preferably include an event status register 410A, an event status mask register 410B, and an end of event status acknowledgement register 410C. As will be discussed below, these registers 410A-C may be used to facilitate more efficient processing. The event status register 410A contains a plurality of bits, such as 32 bits. Each bit (or respective group of bits) represents the status of an event, such as an external event. The event status register 410A preferably includes one or more bits that contain the status of a lock line reservation lost event. The lock line reservation lost event is triggered when a particular command is issued by the APU 400 (e.g., a get lock line and reserve command) and the reservation has been reset due to some entity modifying data in the same lock line of the DRAM 225. The significance of this event will be discussed in more detail later in this description.

In addition to the lock line reservation lost event, events may include signal notification events, decrementer events, SPU mailbox written by PU events, DMA queue vacancy events, DMA tag command stall and notify events, DMA tag status update events, etc.

The signal notification event is triggered when a command is received that targets a signal notification register (not shown) of the APU 400. A signal notification occurs when another processor (or an external device) sends a signal to the APU 400. The signal is sent by writing to a signal notification address of the APU 400. This notification is used so that the other processor can notify the APU 400 that some action needs to be taken by the APU 400. Signal bits may be assigned to specific units by software such that multiple signals can be received together and properly identified by software of the APU 400.

The decrementer event is triggered by a transition in a decrementer count of the APU 400 from a logic 0 to a logic 1. The APU mailbox event is triggered when the PU 203 writes a message to a mailbox (not shown) of the APU 400 such that mailbox data is available from a mailbox channel of the APU 400.

The DMA queue vacancy event is triggered by a transition of a DMA command queue from a full to a non-full state. The DMA queue vacancy event is used by the APU 400 to determine when space is available in the DMA queue to receive more commands. The DMA queue vacancy event need not always be used; instead, it is used when a previous attempt to send a command to the DMAC 205 fails.

The DMA tag command stall and notify event occurs when one or more DMA commands (with list elements having a stall and notify flag set) are received by the memory interface 215 and/or the DMAC 205. When this occurs, the list elements have been completed and the processing of a remainder of the list is suspended until the stall has been acknowledged by a program running on the APU 400. The DMA tag command stall and notify event is used by the APU 400 to determine when a particular command element in the DMA list has been completed. This can be used for synchronization of the program to movement of data, or it can be used to suspend processing of the DMA list such that the APU 400 can modify remaining elements of the DMA list.

The DMA tag status update event occurs when a request for tag status update is written to a particular channel within the APU 400 (this requests a tag status update). The DMA tag status event may be used upon request by the APU 400 to be interrupted (notified) when a particular set of DMA commands have been completed by the DMAC 205. This is used to support DMA transfers concurrently with program execution to provide efficient utilization of resources.

As may be needed during the processing of data, the APU 400 may poll the event status register 410A to determine the state of one or more of these or other events. Preferably, one or more of the events are external to the APU 400 and/or external to a particular PE 201. The event status mask 410B is preferably utilized to mask certain of the bits of the event status register 410A such that only a particular bit or bits are active. Preferably, the data provided by the event status mask register 410B is retained until it is changed by a subsequent write operation. Thus, the data need not be re-specified for each (external) event status query or wait event. Consequently, events that occur while masked will not be indicated in the event status. Mask events, however, will be held pending until unmasked or until acknowledged by writing to the end of event status acknowledgement register 410C. Writing the end of event status acknowledgement register 410C for an event that is pending, but masked, will result in the event being cleared. Indeed, since masked events are preferably held pending until unmasked, acknowledging a mask event that has not been reported in the event status register 410A will result in the event being cleared.

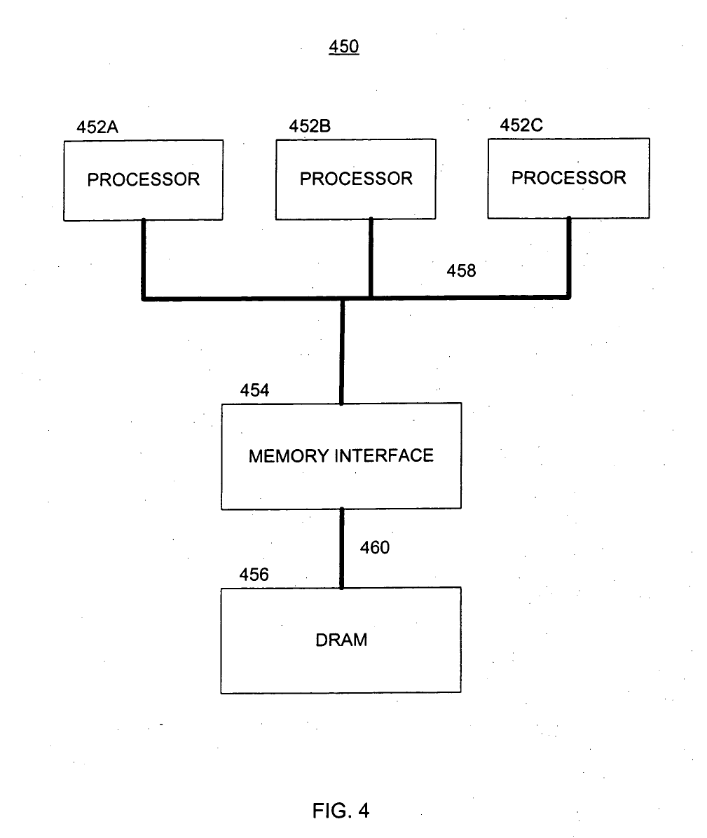

It is noted that while the present invention is preferably carried out using the BE 301 of FIG. 2, alternative multi-processor systems may also be employed. For example, the multi-processor system 450 of FIG. 4 may be used to carry out one or more aspects of the present invention. The multi-processor system 450 includes a plurality of processors 452A-C (any number may be used) coupled to a memory interface 454 over a bus 45B. The memory interface 454 communicates with a shared memory 456, such as a DRAM, over another bus 460. The memory interface 454 may be distributed among the processors 452A-C (as are the memory interfaces 215A-B of FIG. 2) and may also work in conjunction with a DMAC if desired. The processors 452A-C are preferably implemented utilizing the same or similar structure of FIG. 3.

The significance of the event status registers 410A-C (FIG. 3), particularly in connection with the lock line reservation lost event, will become more apparent when a discussion of atomic update primitives for synchronization and/or mutual exclusion are discussed. In order to more fully understand the significant and advantageous aspects of the present invention, an understanding of conventional multi-processor synchronization and/or mutual exclusion operations will be discussed first. Synchronization and mutual exclusion operations are provided by the PEs 201 such that software running on the APUs 400 have the capability to synchronize access to data in the shared memory, DRAM 225, and synchronize execution by the multiple APUs 400. To this end, atomic sequences are provided, which include read sequences, modify sequences, and write sequences. These sequences typically take the form of compare and swap instructions, fetch and NO-OP instructions, fetch and store instructions, fetch and AND instructions, fetch and increment/ADD instructions, and test and set instructions. On the PU 203, these sequences are not actually instructions, but are implemented utilizing software in connection with atomic update primitives, such as load with reservation and store conditional. By way of example, present software implementations of the test and set primitive and the compare and swap primitive utilize the following pseudo code:
loop: load with reservation compare with expected value branch not equal to loop store new value conditionally branch back to look if reservation lost
exit: continue

The above pseudo code sequence and other similar synchronization sequences, require “spinning” on the lock line until the data is equal to the expected value. As this spinning may take place for a significant period of time, wasted CPU cycling and memory cycling results. Thus, the given APU 400 consumes an excessive amount of power and also dissipates an excessive amount of heat.

In accordance with one or more aspects of the invention, one or more events of the event status register 410A, such as the lock line reservation lost event, is used to notify the APU 400 that an atomic update reservation is lost. An atomic update reservation is obtained by utilizing a particular data loading command (e.g., get lock line and reserve). In general, a reservation is lost when a modification of data at a reserved address (a lock line) in the shared memory, DRAM 225, occurs, particularly an external modification. By utilizing this technique, software implementations of the test and set primitive and the compare and swap primitive may be rewritten, such as by the following pseudo code:
loop: load with reservation compare with expected value branch if equal to continue read from external event channel stop and wait for external event if event is “reservation lost” then branch to loop else branch to other task
continue: store new value conditionally branch back to loop if reservation lost

The above pseudo code in combination with the event status register 410A provides a significant reduction in power consumed and, therefore, power dissipated by the APUs 400. In particular, the APUs 400 may enter a “pause mode” or low power consumption mode until a particular external event interrupts that mode. By way of example, the low power consumption mode may be entered by stopping a system clock of the APU 400. Thus, when a particular APU 400 is waiting to acquire a particular piece of data in the shared memory DRAM 225, or when waiting on a synchronizing barrier value, it may enter the low power consumption mode and wait for an external event to interrupt the low power consumption mode. The use of the reservation lost event (as indicated in the event status register 410A) as an external event that is permitted to interrupt the low power consumption mode of the APU 400 is a unique and powerful extension to an atomic update reservation system and advantageously enables more efficient multi-processing.

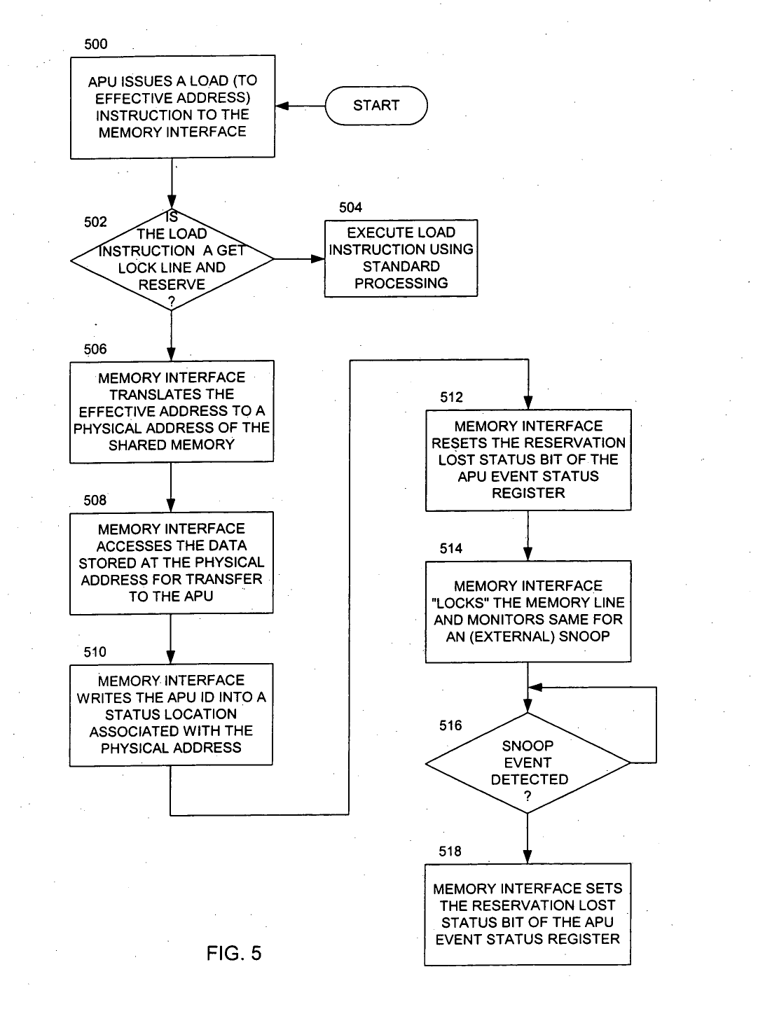

In order to more fully describe the use of the reservation lost event to permit the APUs 400 to participate in atomic updates, reference is now made to FIGS. 3 and 5. FIG. 5 is flow diagram illustrating certain actions that are preferably carried out by one or more of the PEs 201 (FIG. 2). As the start of the process, a particular APU 400 issues a load instruction to the DMAC and/or the memory interface 215 (action 500). It is noted that the DMAC 205 and the memory interface 215 work together to read and write data from and to the DRAM 225. Although these elements are shown as separate elements, they may be implemented as a single unit. In addition, the functions of the DMAC 205 and/or the functions of the memory interface 215 may be referred to as being carried out by “a memory interface” or a “memory management” unit.

The load instruction is preferably a load data with reservation, which has been referred to hereinabove as a get lock line and reserve command. In essence, this is a request for data at a particular effective address of the shared memory DRAM 225. At action 502, the memory interface (the DMAC 205 and/or the memory interface 215) preferably determines whether the load instruction is a standard load instruction or a get lock line and reserve instruction. If the load instruction is a standard instruction, then the process flow preferably branches to action 504, where standard processing techniques are utilized to satisfy the load instruction.

On the other hand, if the load instruction is a get lock line and reserve instruction, then the process flow preferably branches to action 506. There, the memory interface preferably translates the effective address issued by the particular APU 400 to a physical address of the shared memory DRAM 225. At action 508, the memory interface accesses the data stored at the physical address of the DRAM 225 for transfer to the APU 400. Preferably, when the data are accessed from the line or lines at the physical address of the DRAM 225, the memory interface writes an identification number of the APU 400 into a status location associated with that physical address. At action 512, the memory interface 215 preferably resets the reservation lost status bit(s) of the event status register 410A of the APU 400. This locks the one or more memory lines at the physical address. The memory interface preferably monitors this reserved line or lines of the DRAM 225. If another processor, such as a processor external to the particular PE 201, modifies data from the reserved line or lines of the DRAM 225 (action 516), then the memory interface preferably sets the reservation lost status byte of the event status register 410A of the APU 400 that reserved that line or lines (action 518).

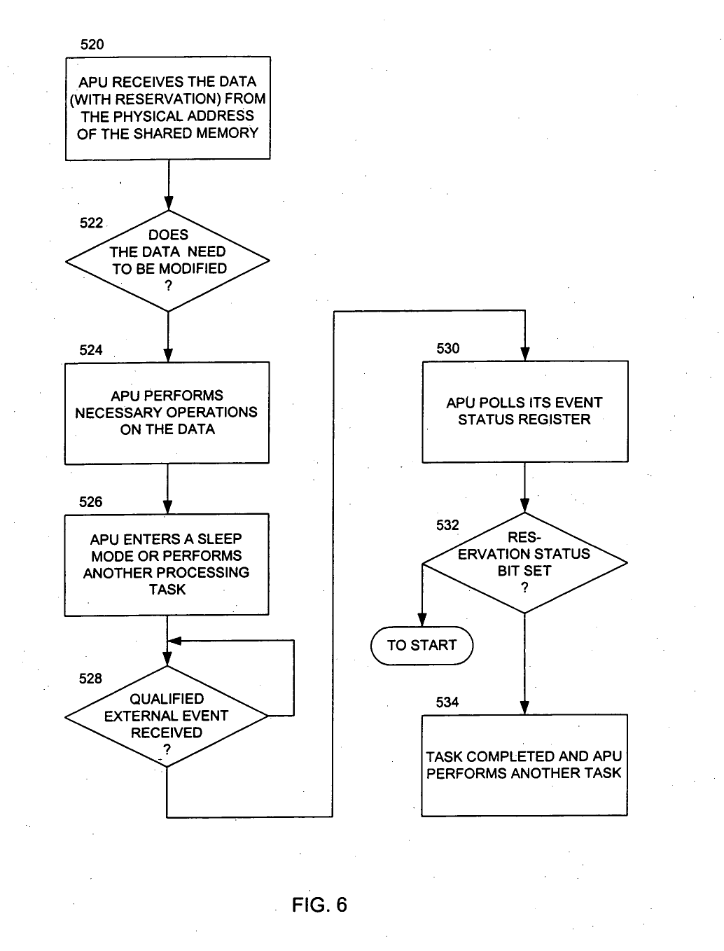

With reference to FIG. 6, while the memory interface is monitoring the reserved line or lines of the DRAM 225 (action 514), the APU 400 preferably receives the requested data (with reservation) from the shared memory DRAM 225 (action 520). If the data needs to be processed (action 522) the APU 400 performs whatever operations are necessary as dictated by the software program running on the APU 400 (action 524). At action 526, the APU 400 enters the low power consumption mode (the sleep mode). By way of example, the APU 400 may enter the low power consumption mode only if the data is not a predetermined value. This has particular use when barrier synchronization is desirable (which will be discussed in greater detail below). The APU 400 remains in this low power consumption mode until a qualified external event occurs (action 528).

By way of example, the external event may be that the reservation was lost (e.g., that an external processor modified the data from the reserved line or lines of the DRAM 225). At action 530, the APU 400 preferably polls the event status register 410A and determines whether the reservation status bit or bits are set (action 532). If the reservation was not lost (e.g., the reservation status bit was not set), then the APU 400 is free to perform other tasks (action 534). If, however, the APU 400 determines that the reservation was lost (e.g., the reservation status bit was set), then the process preferably loops back to the start (FIG. 5) where the process is repeated until the APU 400 performs its data manipulation task without loosing the reservation.

As discussed above, the present invention may be utilized in connection with performing multi-processing in accordance with barrier synchronization techniques. For example, when one of a plurality of processors in a multi-processing system (e.g., the system 450 of FIG. 4) is waiting on a so-called synchronizing barrier value, it may enter the low power consumption mode or initiate the performance of another processing task until an external event, such as a reservation lost event, occurs. The barrier synchronization technique is utilized when it is desirable to prevent a plurality of processors from initiating a next processing task until all the processors in the multi-processing system have completed a current processing task.

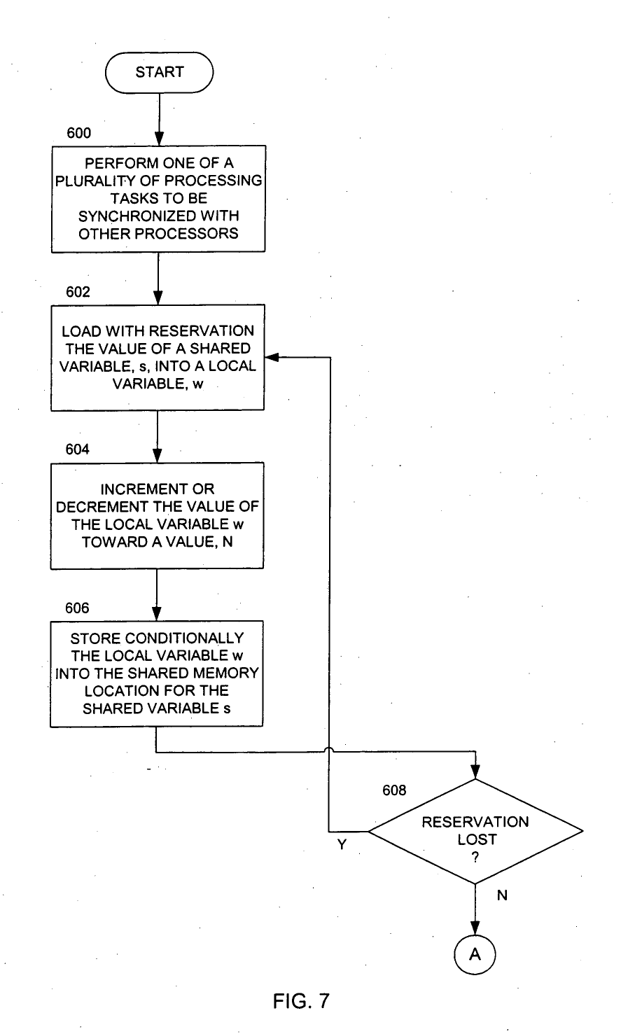

Further details concerning the use of the present invention in connection with barrier synchronization techniques will now be discussed in more detail with reference to FIGS. 4 and 7-8. In accordance with the barrier synchronization technique, a shared variable, s, is stored in the shared DRAM 456 and is utilized to prevent or permit the processors 452A-C from performing a next processing task until all such processors complete a current processing task. More particularly, and with reference to FIG. 7, a given processor 452 performs one of a plurality of processing tasks (e.g., a current processing task) that is to be synchronized with the processing tasks of the other processors (action 600). When the current task is completed, the processor 452 issues a load with reservation instruction to the memory interface 452 to obtain the value of the shared variable s, which is stored as a local variable w (action 602). For the purposes of discussion, it is assumed that the value of the shared variable s is initialized to 0, it being understood that the initial value may be any suitable value. At action 604, the processor 452 increments or decrements the value of the local variable w toward a value of N, where N is representative of the number of processors 452 taking part in the barrier synchronization process. Assuming that the number of processors taking part in the barrier synchronization process is 3, a suitable value of N is 3. In keeping with this example, the processor 452 increments the value of the local variable w at action 604.

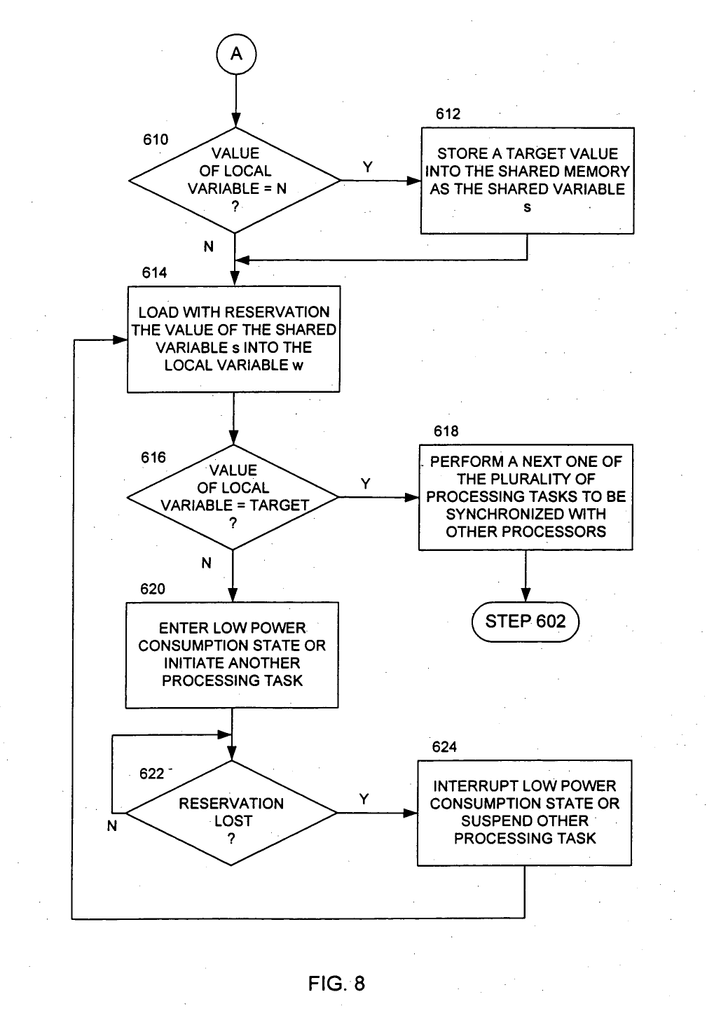

At action 606, the processor 452 issues a store conditionally instruction to facilitate the storage of the value of the local variable w into the shared DRAM 456 in the memory location associated with the shared variable s. Assuming that the value of the shared variable s loaded at step 602 was the initial value of 0, then the value stored conditionally at action 606 would be 1. At action 608, a determination is made as to whether the reservation was lost. If the reservation was lost, then the process flow loops back to action 602 and actions 602, 604, and 606 are repeated. If the reservation was not lost, then the process flow advances to action 610 (FIG. 8). It is noted that the successful storage of the value 1 in the shared variable s indicates that one of the three processors has completed the current processing task.

At action 610, a determination is made as to whether the value of the local variable w is equal to N. If the determination is affirmative, then the process flow advances to action 612, where a target value is stored as the shared variable s in the shared DRAM 456. Thereafter, the process flow advances to action 614, which is also where the process flow advances when the determination at action 610 is negative. At action 614, the processor 452 issues a load with reservation instruction to the memory interface 454 in order to obtain the value of the shared variable s from the shared DRAM 456 and to store same into the local variable w.

At action 616, a determination is made as to whether the value of the local variable w is equal to the target value. By way of example, the target may be 0 or some other number. If the determination is affirmative, then the process flow preferably advances to action 618, where a next one of the plurality of processing tasks is performed. In other words, when the value of the shared variable s is set to the target value, then the processors 452 are permitted to initiate the next processing task. If the determination at action 616 is negative, then the process flow preferably advances to action 620, where the processor 452 either enters a low power consumption state or initiates another processing task not associated with the barrier synchronization process.

At action 622, a determination is made as to whether the reservation was lost (i.e., the load with reservation of action 614). If not, the processor 452 remains in the state of action 620. When the reservation is lost, however, the low power consumption state is interrupted (or the other processing task is suspended or terminated) at action 624 and the process loops back to action 614. Actions 614, 616, 620, 622, and 624 are repeated until the determination at action 616 is in the affirmative, whereby the process flow advances to action 618 and the next one of the plurality of processing tasks is initiated. Once the processor 452 completes the next processing task, the process flow loops back to action 602, where the entire process is repeated.

Advantageously, the use of atomic updating principles in the barrier synchronization technique permits the processors 452 participating in the barrier synchronization process to enter the low power consumption state or to initiate another processing task (action 620), which reduces power consumption and dissipation and improves the efficiency of the overall multi-processing function.

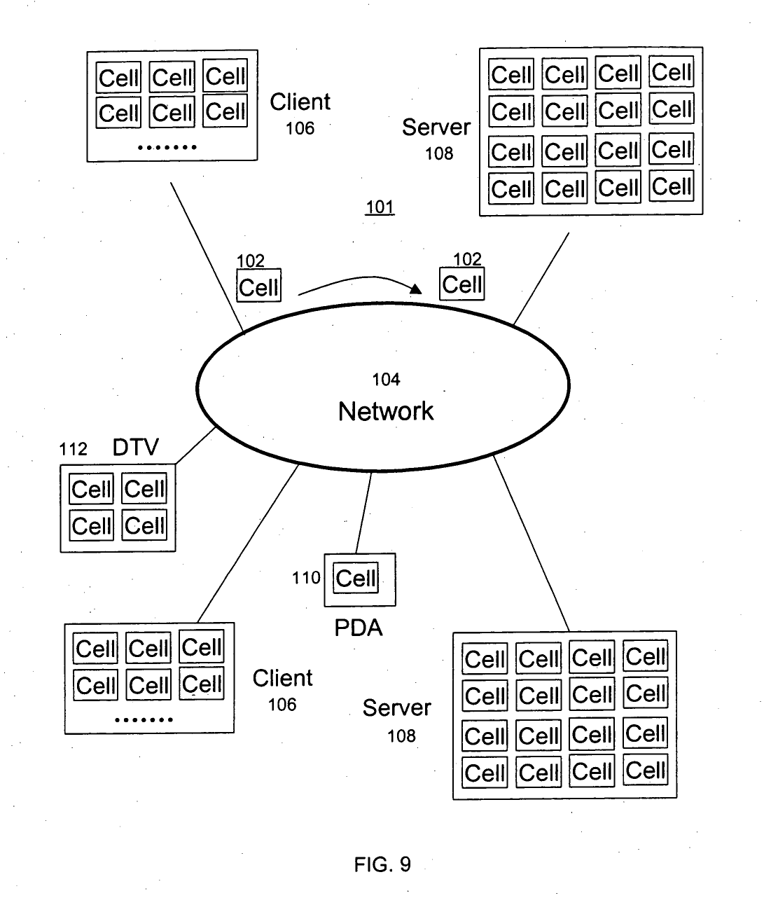

In accordance with one or more further aspects of the present invention, the PEs 201 and/or BEs 301 may be used to implement an overall distributed architecture for a computer system 101 as shown in FIG. 9. System 101 includes network 104 to which a plurality of computers and computing devices are connected. Network 104 can be a LAN, a global network, such as the Internet, or any other computer network.

The computers and computing devices connected to network 104 (the network's “members”) include, e.g., client computers 106, server computers 108, personal digital assistants (PDAs) 110, digital television (DTV) 112 and other wired or wireless computers and computing devices. The processors employed by the members of network 104 are constructed from the PEs 201 and/or BEs 301.

Since servers 108 of system 101 perform more processing of data and applications than clients 106, servers 108 contain more computing modules than clients 106. PDAs 110, on the other hand, in this example perform the least amount of processing. PDAs 110, therefore, contain the smallest number of computing modules. DTV 112 performs a level of processing between that of clients 106 and servers 108. DTV 112, therefore, contains a number of computing modules between that of clients 106 and servers 108.

This homogeneous configuration for system 101 facilitates adaptability, processing speed and processing efficiency. Because each member of system 101 performs processing using one or more (or some fraction) of the same computing module (PE 201), the particular computer or computing device performing the actual processing of data and applications is unimportant. The processing of a particular application and data, moreover, can be shared among the network's members. By uniquely identifying the cells comprising the data and applications processed by system 101 throughout the system, the processing results can be transmitted to the computer or computing device requesting the processing regardless of where this processing occurred. Because the modules performing this processing have a common structure and employ a common ISA, the computational burdens of an added layer of software to achieve compatibility among the processors is avoided. This architecture and programming model facilitates the processing speed necessary to execute, e.g., real-time, multimedia applications.

To take further advantage of the processing speeds and efficiencies facilitated by system 101, the data and applications processed by this system are packaged into uniquely identified, uniformly formatted software cells 102. Each software cell 102 contains, or can contain, both applications and data. Each software cell also contains an ID to globally identify the cell throughout network 104 and system 101. This uniformity of structure for the software cells, and the software cells' unique identification throughout the network, facilitates the processing of applications and data on any computer or computing device of the network. For example, a client 106 may formulate a software cell 102 but, because of the limited processing capabilities of client 106, transmit this software cell to a server 108 for processing. Software cells 102 can migrate, therefore, throughout network 104 for processing on the basis of the availability of processing resources on the network 104.

The homogeneous structure of processors and software cells 102 of system 101 also avoids many of the problems of today's heterogeneous networks. For example, inefficient programming models which seek to permit processing of applications on any ISA using any instruction set, e.g., virtual machines such as the Java virtual machine, are avoided. System 101, therefore, can implement broadband processing far more effectively and efficiently than conventional networks.

Preferably, one or more members of the computing network utilize the reservation lost event as a trigger to permit interruption of a low power consumption mode of a particular APU 400. Further, if a reservation is lost, the APU 400 preferably repeats its data manipulation task until it is completed without a loss of reservation in the shared memory DRAM 225. This is a unique and powerful extension to an atomic update reservation system and enables more efficient multi-processing.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
a) issuing a load with reservation instruction including a requested address to a shared memory at which data may be located;
b) receiving the data from the shared memory such that any operations may be performed on the data;
c) at least one of: (i) entering a low power consumption mode, and (ii) initiating another processing task; and
d) receiving notification that the reservation was lost, the reservation being lost when the data at the address in shared memory is modified.

2. The method of claim 1, wherein the notification that the reservation was lost operates as an interrupt that at least one of (i) interrupts the low power consumption mode;
and (ii) interrupts the other processing task.

3. The method of claim 1, wherein the step of entering the low power consumption mode or the step of initiating another processing task is carried out only if the data is not a predetermined value.

4. The method of claim 3, further comprising repeating steps a) through d) when the notification indicates that the reservation was lost.

5. The method of claim 1, further comprising: writing an identification number, associated with a processor issuing the load with reservation instruction, into a status location associated with the addressed location in the shared memory when the data is accessed from the shared memory.

6. The method of claim 1, further comprising: causing a reservation lost bit in a status register of the processor to indicate that the reservation was lost when the data at the address in shared memory is modified.

7. The method of claim 6, wherein the step of determining whether the reservation was lost includes polling the status register and determining that the reservation was lost when the reservation lost bit so indicates.

8. A system, comprising:
a shared memory;
a memory interface unit operatively coupled to the shared memory; and
a plurality of processing units in communication with the memory interface, at least one of the processing units being operable to:
a) issue a load with reservation instruction to the memory interface unit, the load with reservation instruction including a requested address to the shared memory at which data may be located;
b) receive the data from the memory interface unit such that any operations may be performed on the data;
c) at least one of: (i) enter a low power consumption mode, and (ii) initiate another processing task; and
d) receive notification that the reservation was lost, the reservation being lost when the data at the address in shared memory is modified.

9. The system of claim 8, wherein the notification that the reservation was lost operates as an interrupt that at least one of (i) interrupts the low power consumption mode;
and (ii) interrupts the other processing task.

10. The system of claim 8, wherein the at least one processing unit is operable to enter the low power consumption mode or initiate the other processing task only if the data is not a predetermined value.

11. The system of claim 10, wherein the at least one processor is further operable to repeat steps a) through d) when the notification indicates that the reservation was lost.

12. A system, comprising:
a shared memory;
a memory interface unit coupled to the shared memory and operable to retrieve data from the shared memory at requested addresses, and to write data to the shared memory at requested addresses; and
a plurality of processing units in communication with the memory interface and operable to instruct the memory interface unit that data be loaded with reservation from the shared memory at a specified address such that any operations may be performed on the data,
wherein at least one of the processing units includes a status register having one or more bits indicating whether a reservation was lost, the reservation being lost when the data at the specified address in shared memory is modified by another one or more of the processing units.

13. The system of claim 12, wherein the at least one processing unit is operable to enter a low power consumption mode if the data is not a predetermined value.

14. The system of claim 13, wherein the at least one processing unit is further operable to exit the low power consumption mode in response to an event that is permitted to interrupt the low power consumption mode.

15. The system of claim 14, wherein the at least one processing unit is further operable to poll the one or more bits of the status register to determine whether the reservation was lost.

16. The system of claim 15, wherein the at least one processing unit is further operable to (i) re-instruct the memory interface unit to load the data with reservation from the shared memory at the specified address such that any operations may be performed on the data.

17. The system of claim 14, wherein the event that is permitted to interrupt the low power consumption mode is that the reservation was lost.

18. The system of claim 11, wherein the memory interface unit is operable to write an identification number, associated with the at least one processing unit issuing the load with reservation instruction, into a status location associated with the specified address of the shared memory when the data is accessed from the shared memory.

19. The system of claim 12, wherein the memory interface unit is operable to monitor whether the reservation is lost by monitoring whether the data at the specified address in shared memory is modified by another of the processing units.

20. The system of claim 19, wherein the memory interface unit is operable to cause the one or more bits of the status register of the at least one processing unit to indicate that the reservation was lost.

21. A system, comprising:
a shared memory;
a memory interface unit coupled to the shared memory and operable to retrieve data from the shared memory at requested addresses, and to write data to the shared memory at requested addresses; and
a plurality of processing units in communication with the memory interface and operable to (i) instruct the memory interface unit that data be loaded with reservation from the shared memory at a specified address such that any operations may be performed on the data,
wherein at least one processing unit is operable to at least one of: (i) enter into a low power consumption mode after issuing the instruction that the data be stored in the shared memory at the specified address; and (ii) initiate another processing task.

22. The system of claim 21, wherein the at least one processing unit is operable to enter the low power consumption mode or initiate the other processing task only if the data is not a predetermined value.

23. The system of claim 21, wherein the at least one processing unit is further operable to at least one of (i) exit the low power consumption mode, and (ii) suspend the other processing task, in response to an indication that the reservation was lost.

24. The system of claim 21, wherein the at least one processing unit includes a status register having one or more bits indicating whether a reservation was lost, the reservation being lost when the data at the specified address in shared memory is modified.

25. The system of claim 24, wherein the memory interface unit is operable to cause the one or more bits of the status register of the at least one processing unit to indicate that the reservation was lost.

26. The system of claim 24, wherein the at least one processing unit is further operable to poll the one or more bits of the status register to determine whether the reservation was lost.

27. The system of claim 25, wherein the at least one processing unit is further operable to (i) re-instruct the memory interface unit to load the data with reservation from the shared memory at the specified address such that any operations may be performed on the data.

28. The system of claim 21, wherein the memory interface unit is operable to write an identification number, associated with the at least one processing unit issuing the load with reservation instruction, into a status location associated with the specified address of the shared memory when the data is accessed from the shared memory.

29. A system, comprising:
a shared memory;
a memory interface unit operatively coupled to the shared memory; and
a plurality of N processing units in communication with the memory interface, the processing units being operable to execute a plurality of tasks in parallel using barrier synchronization by:
a) performing one of the plurality of tasks;
b) initializing a local variable, w;
c) issuing a load with reservation instruction to the memory interface unit to load a shared variable, s, from the shared memory into the local variable w;
d) incrementing or decrementing the local variable w toward the value of N;
e) issuing a store conditionally instruction to the memory interface unit to facilitate storage of the value of the local variable w as the shared variable s in the shared memory;
f) repeating steps a)-e) if the reservation is lost, the reservation being lost when the shared variable at the address in shared memory is modified;
g) issuing a store instruction to the memory interface unit to facilitate storage of a target value as the shared variable s in the shared memory when the value of the local variable reaches N;
h) issuing a load with reservation instruction to the memory interface unit to load the shared variable s from the shared memory into the local variable w;
i) entering a low power consumption mode, or initiating another processing task, when the value of the local variable is not the target value otherwise skip to step k);
j) exiting the low power consumption mode, or suspending the other processing task, and repeat steps h)-i) upon receipt of notification that the reservation was lost, the reservation being lost when a request for the shared variable in the shared memory is made by another processor; and
k) performing a next one of the plurality of tasks.
